(19) United States
(12) Patent Application Publication
(10) Pub. No.: US 2026/0267174 A1
(43) Pub. Date: Sep. 10, 2026

(54) OPTICAL WAVEGUIDE ELEMENT, AND OPTICAL MODULATION DEVICE AND OPTICAL TRANSMISSION DEVICE USING SAME

(71) Applicant: SUMITOMO OSAKA CEMENT CO., LTD., Tokyo (JP)

(72) Inventors: Hideki ICHIMEI, Tokyo (JP); Makoto SHIMADA, Tokyo (JP)

(73) Assignee: SUMITOMO OSAKA CEMENT CO., LTD., Tokyo (JP)

(21) Appl. No.: 18/849,339

(22) PCT Filed: Mar. 30, 2022
(86) PCT No.: PCT/JP2022/016213

§ 371 Date: Sep. 20, 2024

(51) Int. Cl. G02F 1/035

(52) U.S. Cl. CPC G02F 1/035

(57) ABSTRACT

An object of the present invention is to provide an optical waveguide device that reduces internal stress generated in a joint portion between a substrate or a reinforcing block and an optical component and that suppresses residual air bubbles in an adhesive. An optical waveguide device of the present invention includes a substrate 1 on which an optical waveguide 10 is formed, a reinforcing block 3 disposed on the substrate 1 along an end surface of the substrate 1 on which an input portion or an output portion of the optical waveguide 10 is disposed, and an optical component 4 joined to end surfaces of the substrate 1 and the reinforcing block 3, in which grooves (CH1(IN) and the like) are disposed near a part corresponding to the input portion of the output portion on a joint surface of the optical component 4, and a part (CH1(OUT) and the like) of the grooves reaches up to a side surface adjacent to the joint surface.

### TECHNICAL FIELD

The present invention relates to an optical waveguide device, and an optical modulation device and an optical transmission apparatus using the same, and particularly to an optical waveguide device including a substrate on which an optical waveguide is formed and a reinforcing block disposed on the substrate along an end surface of the substrate on which an input portion or an output portion of the optical waveguide is disposed.

### BACKGROUND ART

In the field of optical measurement technology or in the field of optical communication technology, optical waveguide devices such as an optical modulator using a substrate on which an optical waveguide is formed have been widely used. An optical modulation element (a lithium niobate (LN) chip) is formed by forming a control electrode for controlling a light wave propagating through the optical waveguide on the optical waveguide device using the substrate of LN or the like having an electro-optic effect. The LN chip is mounted inside a case of metal or the like, and an optical component such as an optical lens is adhesively fixed to an end surface of the optical waveguide device to input the light wave into the optical waveguide of the optical waveguide device or output the light wave from the optical waveguide of the optical waveguide device.

FIG. 1 is a side view for describing a summary of the optical waveguide device. FIG. 2 is a perspective view illustrating a part of the optical waveguide device in FIG. 1. In order to join an optical component 4 to a substrate 1 (11) on which an optical waveguide is formed, a reinforcing block 3 is fixedly disposed on an upper side of the substrate 1 (11). Furthermore, the optical component 4 is joined to the substrate 1 (11) and an end surface of the reinforcing block 3 with an adhesive AD. In recent years, a thin plate 1 having a thickness of several μm or lower has also been used as the substrate for forming the optical waveguide. In this case, as illustrated in FIG. 1, the reinforcing substrate 11 and the thin plate 1 are directly joined to each other or joined through an adhesive. While a buffer layer that covers the optical waveguide, an electrode for controlling a light wave that propagates through the optical waveguide, and the like are formed on the upper side of the substrate 1, the buffer layer, the electrode, and the like are simply illustrated as an upper surface-side layer 2 in FIG. 1.

Ferroelectric materials such as LN are used as the substrate constituting the optical waveguide device, and materials such as LN are also used in the reinforcing block to match linear expansion coefficients between the reinforcing block and the substrate 1. On the other hand, glass (organic glass, optical glass, and the like) and plastic are used as a material of the optical component. The linear expansion coefficient of LN is anisotropic and is 7.5×10⁻⁶/° C. in a Z-axis direction and 14.4×10⁻⁶/° C. in an X-axis (Y-axis) direction. On the other hand, a representative linear expansion coefficient of the optical component is 6.5×10⁻⁶/° C. Thus, in a case where each member expands thermally, an amount of change related to expansion of each member on a joint surface varies, and this causes the joint surface to peel off or generates internal stress that applies stress to the optical waveguide or the like, resulting in unstable characteristics of the optical waveguide device. The stress also causes problems such as breakage of the substrate 1 of the thin plate.

It is also difficult to control an application amount of the adhesive. Thus, as illustrated in FIGS. 1 and 2, the adhesive protrudes outside an adhesive application region of the optical component 4, for example, to an upper portion of the reinforcing block 3. This protruding part of the adhesive increases an adhesion area between the optical component and the reinforcing block in a longitudinal direction. Thus, after a temperature cycle test, the optical component moves slightly from a position at which the optical component is fixed, because of a difference in the linear expansion coefficient between the optical component and the reinforcing block in the longitudinal direction. Thus, an optical axis deviates, and an insertion loss is increased. This problem is even more noticeable in an optical waveguide device having a folded optical waveguide, such as an HB-CDM modulator, in which a width of the substrate 1 or the reinforcing block 3 is more than that of an optical modulator in the related art.

In order to solve such a problem, Patent Literature No. 1 suggests reducing an area of the joint surface of the optical component 4. Specifically, there is a method of reducing the area of the joint surface by cutting a part of the optical component (optical block). However, the optical waveguide device provided with a notch has poor stability and also has poor workability because the optical waveguide device is likely to fall during work of fixedly disposing the optical waveguide device in the case. The workability is particularly poor in a case where the notch is provided on a bottom surface side of the optical component.

Patent Literature No. 1 also suggests forming a groove surrounding the adhesive application region on the joint surface of the optical component in order to restrict the adhesive application region.

In a case where the groove surrounding the adhesive application region is provided as in Patent Literature No. 1, it is difficult to remove air bubbles included in the adhesive, air pockets (air bubbles) generated in applying the adhesive and pressing the optical component against the reinforcing block, and the like outside the optical waveguide device. In a case where air bubbles remain in the adhesive, curing the adhesive in a state where air bubbles are included inside the adhering surface increases the insertion loss of light after a temperature cycle test because a structure of the groove is present only inside the adhering surface. In a case where air bubbles overlap with a position near the optical axis at which the light wave propagates, particularly a position of the lens of the optical component or a position at which the optical waveguide of the thin plate is formed, light is scattered, and this causes an increase in an optical loss.

### Citation List

### Patent Literature

[Patent Literature No. 1] Japanese Laid-open Patent Publication No. 2021-162645

### SUMMARY OF INVENTION

### Technical Problem

An object to be solved by the present invention is to solve the above problem and provide an optical waveguide device that reduces internal stress generated in a joint portion between a substrate or a reinforcing block and an optical component and that suppresses residual air bubbles in an adhesive. It is also an object to provide an optical waveguide device configured not to have residual air bubbles on an optical axis or a propagation optical path of a light wave even in a case where air bubbles remain in an adhesive. It is also an object to provide an optical modulation device and an optical transmission apparatus using the optical waveguide device.

### Solution to Problem

In order to solve the object, an optical waveguide device of the present invention, and an optical modulation device and an optical transmission apparatus using the same have the following technical features.

(1) An optical waveguide device includes a substrate on which an optical waveguide is formed, a reinforcing block disposed on the substrate along an end surface of the substrate on which an input portion or an output portion of the optical waveguide is disposed, and an optical component joined to end surfaces of the substrate and the reinforcing block, in which grooves are disposed near a part corresponding to the input portion or the output portion on a joint surface of the optical component, and a part of the grooves reaches up to a side surface adjacent to the joint surface.

(2) In the optical waveguide device according to (1), the joint surface of the optical component includes a butting part divided by the grooves, and the butting part is disposed at each of a position corresponding to the substrate and a position corresponding to the reinforcing block.

(3) In the optical waveguide device according to (1) or (2), the grooves are a plurality of straight lines laterally crossing the joint surface of the optical component.

(4) In the optical waveguide device according to (3), the grooves include at least two grooves of straight line shapes which interpose the input portion or the output portion of the optical waveguide in an up-down direction.

(5) In the optical waveguide device according to (4), a width of a groove in the up-down direction at a position corresponding to the reinforcing block is larger than a width of a groove in the up-down direction at a position corresponding to the substrate.

(6) An optical modulation device includes the optical waveguide device according to (1) or (2) including an electrode that modulates a light wave propagating through the optical waveguide, a case accommodating the optical waveguide device, and an optical fiber through which the light wave is input into the optical waveguide or output from the optical waveguide.

(7) In the optical modulation device according to (6), an electronic circuit that amplifies a modulation signal to be input into the optical waveguide device is provided inside the case.

(8) An optical transmission apparatus includes the optical modulation device according to (6), and an electronic circuit that outputs a modulation signal causing the optical modulation device to perform a modulation operation.

### Advantageous Effects of Invention

In the present invention, an optical waveguide device includes a substrate on which an optical waveguide is formed, a reinforcing block disposed on the substrate along an end surface of the substrate on which an input portion or an output portion of the optical waveguide is disposed, and an optical component joined to end surfaces of the substrate and the reinforcing block, in which grooves are disposed near a part corresponding to the input portion or the output portion on a joint surface of the optical component, and a part of the grooves reaches up to a side surface adjacent to the joint surface. Thus, the grooves can suppress spreading of an adhesive, and air bubbles in the adhesive can be discharged to the outside through the groove that reaches up to the side surface. Accordingly, air bubbles can be excluded particularly from a position corresponding to the input portion or the output portion of the optical waveguide.

### BRIEF DESCRIPTION OF DRAWINGS

FIG. 1 is a side view illustrating an example of an optical waveguide device in the related art.

FIG. 2 is a perspective view of the optical waveguide device in FIG. 1.

FIG. 3 is a plan view illustrating a first example of an optical waveguide device of the present invention.

FIG. 4 is a cross-sectional view taken along alternate long and short dash line IV-IV in FIG. 3.

FIG. 5 is a side view seen in a direction of arrow V-V in FIG. 3.

FIG. 6 is a diagram illustrating a joint surface of an optical component seen in a direction of arrow VI-VI in FIG. 3.

FIG. 7 is a diagram for describing a second example of the optical waveguide device of the present invention and is a diagram illustrating the joint surface of the optical component.

FIG. 8 is a cross-sectional view for describing a third example of the optical waveguide device of the present invention.

FIGS. 9A to 9C are cross-sectional views of the optical component for describing a fourth example of the optical waveguide device of the present invention.

FIG. 10 is a diagram for describing a fifth example of the optical waveguide device of the present invention and is a diagram illustrating the joint surface of the optical component.

FIG. 11 is a diagram for describing a sixth example of the optical waveguide device of the present invention and is a diagram illustrating the joint surface of the optical component.

FIG. 12 is a top view seen in a direction of arrow XII-XII in FIG. 11.

FIG. 13 is a side view seen in a direction of arrow XIII-XIII in FIG. 11.

FIG. 14 is a plan view for describing an optical modulation device and an optical transmission apparatus of the present invention.

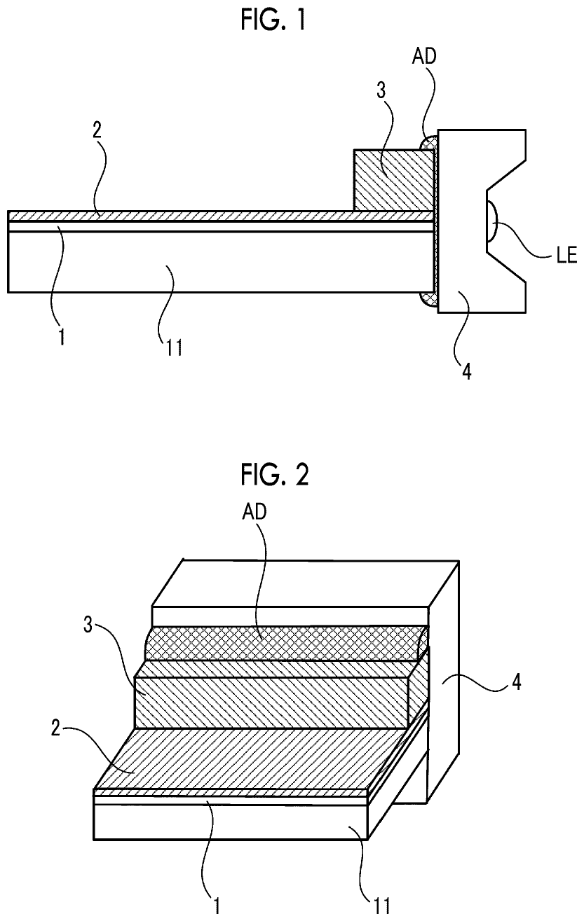

### DESCRIPTION OF EMBODIMENTS

Hereinafter, an optical waveguide device of the present invention will be described in detail using preferred examples.

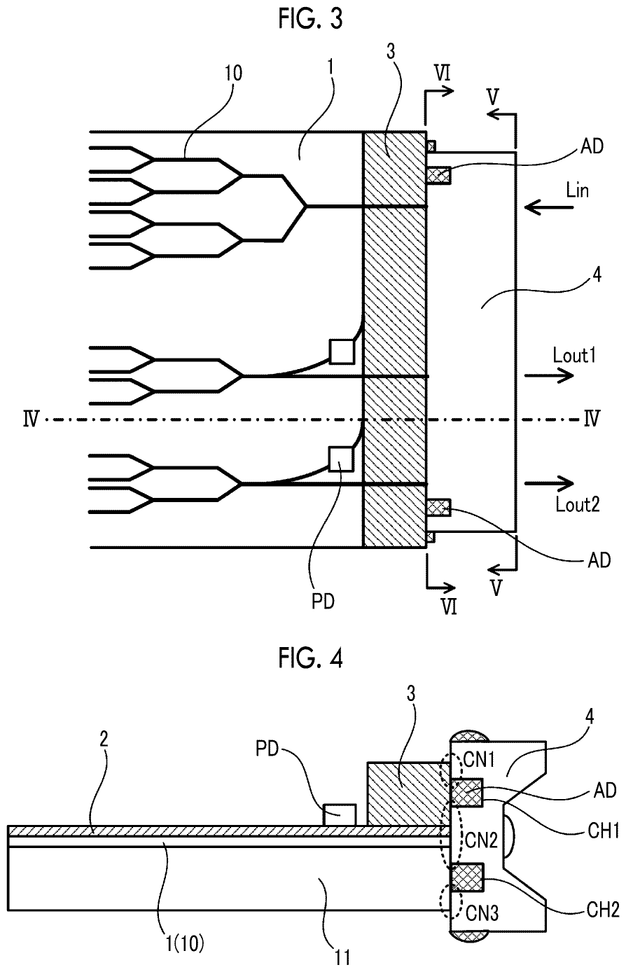

As illustrated in FIGS. 3 to 13, the optical waveguide device of the present invention includes a substrate 1 on which an optical waveguide 10 is formed, a reinforcing block 3 disposed on the substrate along an end surface of the substrate on which an input portion or an output portion of the optical waveguide is disposed, and an optical component 4 joined to end surfaces of the substrate 1 (11) and the reinforcing block 3, in which grooves (CH1(IN) and the like) are disposed near a part corresponding to the input portion or the output portion on a joint surface of the optical component, and a part (CH1(OUT) and the like) of the grooves reaches up to a side surface adjacent to the joint surface.

As a material of the substrate 1 used in the optical waveguide device of the present invention, a substrate of a ferroelectric material having an electro-optic effect, specifically lithium niobate (LN), lithium tantalate (LT), lead lanthanum zirconate titanate (PLZT), or the like, a vapor-phase growth film formed of these materials, or the like can be used. Various materials such as semiconductor materials or organic materials can also be used as the substrate of the optical waveguide device.

A thickness of the substrate 1 on which the optical waveguide is formed may be set to 10 μm or lower and more preferably 5 μm or lower in order to achieve velocity matching between a microwave of a modulation signal and a light wave. In this case, a reinforcing substrate having a thickness of 0.2 to 1 mm is bonded through direct joining or an adhesive to reinforce mechanical strength of the substrate 1.

In the optical waveguide device of the present invention, the “substrate on which the optical waveguide is formed” does not simply mean only one substrate and is a concept also including a joint body of a thin plate (for example, having a thickness of 10 μm or lower) on which the optical waveguide is formed and the reinforcing substrate 11 that supports the thin plate.

The “substrate on which the optical waveguide is formed” also includes a substrate obtained by forming a vapor-phase growth film on a reinforcing substrate and processing the film to have a shape of an optical waveguide.

As a method of forming the optical waveguide 10 on the substrate 1, a method of thermally diffusing a high-refractive index material such as Ti in the substrate or a method of forming a high-refractive index part using a proton exchange method can be used. A rib optical waveguide obtained by forming a part corresponding to the optical waveguide to have a protruding shape in the substrate can also be formed using a method of etching a substrate part other than the optical waveguide, a method of forming grooves on both sides of the optical waveguide, or the like. The rib optical waveguide and the optical waveguide obtained using the thermal diffusion method or the like can also be used together.

Various upper surface-side layers 2 such as a buffer layer formed of SiO₂ or a resin and a metal film constituting an electrode are provided on an upper side of the substrate 1, as necessary.

A photo detector (PD) for detecting a part of the light wave propagating through the optical waveguide 10 may also be disposed, as illustrated in FIGS. 3 and 4.

The reinforcing block 3 using the same material as the substrate 1 such as LN is fixedly disposed on an upper portion of the substrate 1 on a side closer to the end surface. The end surface (a surface on the same side as the end surface of the substrate 1) of the reinforcing block 3 is used as a joint surface for joining the optical component 4 such as an optical block.

The optical component 4 includes the optical block that holds an optical lens, a reflective member, a polarizer, or the like, a holding member having a sleeve (cylindrical) shape or a V-groove substrate that holds an optical fiber near an end portion of the optical fiber, and the like. A glass material such as organic glass or optical glass or a plastic material is used as a material constituting the optical component.

In the present invention, positional deviation of the optical component and peeling or detaching of the optical component caused by a difference in a linear expansion coefficient between the substrate 1 (11) or the reinforcing block 3 and the optical component 4 are prevented. As a specific configuration, grooves (CH1 to CH4) are formed on the joint surface of the optical component, as illustrated in FIG. 4.

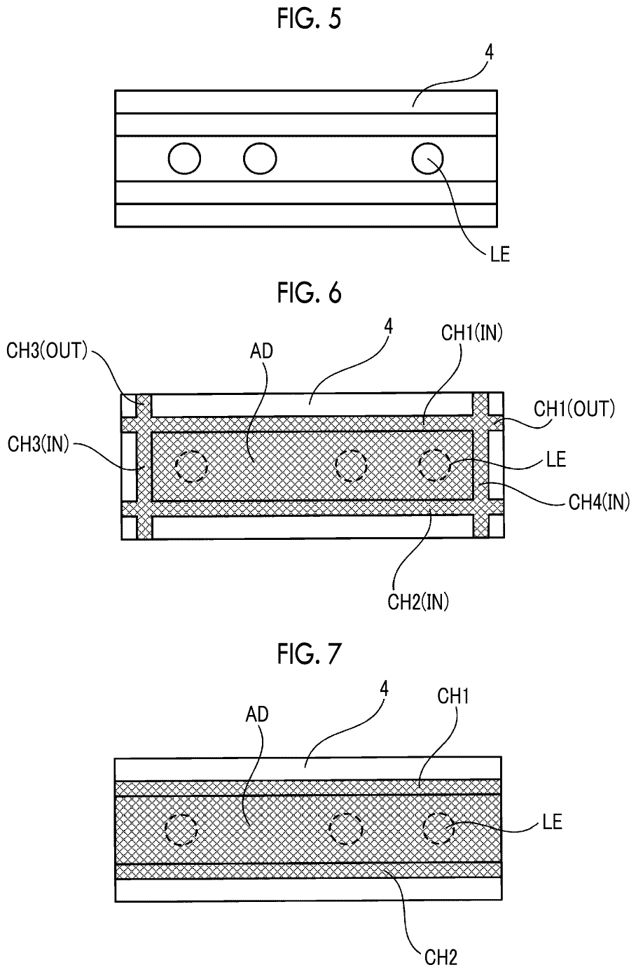

Dotted line LE in FIG. 6 indicates a part corresponding to an optical lens LE of the optical component illustrated in FIG. 5, and a position of LE is also a position corresponding to the input portion and the output portion of the optical waveguide formed on the substrate 1.

While the grooves are illustrated as a set of straight line shapes in FIG. 6, the grooves are not limited to straight lines. The grooves include groove parts (CH1(IN) to GH4(IN) ) disposed near a position corresponding to the input portion or the output portion of the optical waveguide (a part corresponding to reference sign LE). As illustrated in FIG. 6, the grooves disposed near the input portion or the output portion of the optical waveguide may be disposed to surround the input portion or the output portion. The grooves in FIG. 6 further include other grooves (CH1(OUT) and CH3(OUT)) that connect the groove parts disposed nearby to the outside.

The “grooves disposed near the input portion or the output portion of the optical waveguide” in the present invention mainly mean grooves formed on a “joint surface of the optical component” and particularly indicate grooves into which an excess of the adhesive applied to the part corresponding to the input portion or the output portion of the optical waveguide flows.

In a case where the grooves formed on the joint surface of the optical component are a plurality of straight lines laterally crossing the joint surface, the grooves can be formed using cutting means such as a dicing saw, and a manufacturing process is simplified. While the grooves preferably reach up to an outer peripheral part of the joint surface, at least one end of the grooves is configured to be connected to the outside.

By providing two grooves (CH1 and CH2) in a lateral direction as illustrated in FIG. 6, three butting parts (dotted-line parts CN1 to CN3) are formed on the joint surface of the optical component 4, as illustrated in FIG. 4. The butting part CN1 abuts on the reinforcing block 3. The butting part CN2 abuts on a boundary part (the input portion or the output portion of the optical waveguide) between the substrate 1 and the reinforcing block 3. The butting part CN3 abuts on the reinforcing substrate 11 connected to the substrate (thin plate) 1.

In a case where a clearance between a plurality of butting parts is large like the butting parts CN1 and CN3 in FIG. 4, joining between the substrate 1 (reinforcing substrate 11) or the reinforcing block and the optical component 4 can be more stably positioned. By further providing two grooves (CH3 and CH4) in a longitudinal direction as illustrated in FIG. 6, nine butting parts divided by each groove are formed. Accordingly, the entire joint surface of the optical component 4 can be stably positioned.

In the butting parts, air bubbles are pushed out to a side closer to the grooves together with the adhesive in joining the optical component. Thus, in the butting parts, only an extremely thin adhesive layer is present, and air bubbles are also almost not present. The adhesive pushed out from the butting parts moves through the grooves, and an extra adhesive is discharged to the outside.

As illustrated in FIGS. 4 and 6, the butting part (CN2) of the part corresponding to the input portion or the output portion of the optical waveguide includes another butting part in an up-down direction or a left-right direction. Thus, the joint surface of the optical component can be maintained parallel to the joint surface of the substrate 1 (reinforcing substrate 11) or the reinforcing block 3. Accordingly, a thickness of the adhesive layer of the butting part (CN2) is small and stable. Thus, the insertion loss of light is stable. In a case where the thickness of the adhesive layer is increased, the adhesive burns in a case where light of high power is input, and this causes an increase in the insertion loss.

As illustrated in FIG. 6, since the extra adhesive flows into the grooves, the adhesive AD almost does not adhere to the butting parts positioned outside the grooves. Thus, an adhesion area can be reduced, and generation of the internal stress during thermal expansion can be suppressed.

FIG. 7 is another example in which a pattern of the grooves is changed. Two grooves are formed in the up-down direction so that the input portion or the output portion of the optical waveguide is interposed between the grooves. Even with this simple configuration, the adhesive does not spread to the butting parts (CN1 and CN3) other than the butting part CN2, and the extra adhesive is discharged to the outside through the grooves (CH1 and CH2), as in FIG. 4.

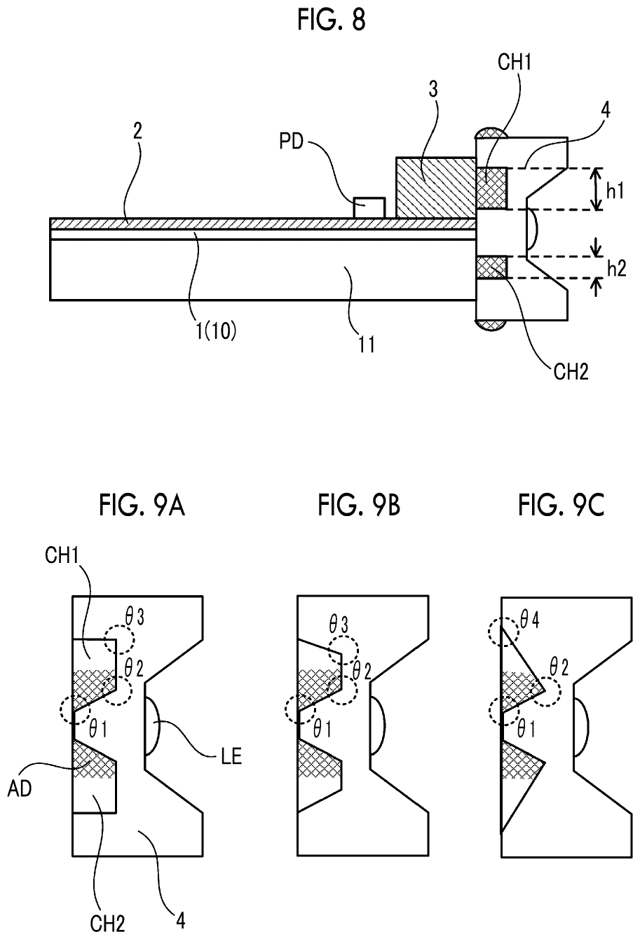

FIG. 8 is a diagram for describing widths (h1 and h2) of the groove parts. For example, a thickness including the substrate 1 and the reinforcing substrate 11 is 0.5 mm, and a thickness of the reinforcing block is 0.5 mm. In a case where a diameter of the lens of the optical component is 0.32 mm, a width (a height in the up-down direction in the drawing) of the butting part corresponding to a position of the lens needs to be more than or equal to a diameter of the lens and specifically, is set to approximately 0.32 to 0.55 mm. This width is set by a clearance between the grooves (CH1 and CH2) disposed in the up-down direction. It is also preferable to secure approximately 0.1 mm for each of the widths in contact with the upper butting part and the lower butting part. Thus, each of the widths h1 and h2 of the grooves is set to approximately 0.125 mm.

With respect to differences in the adhesion area and the linear expansion coefficient between the optical component 4 and the reinforcing block 3 or between the optical component 4 and the reinforcing substrate 11, in a case where the difference in the linear expansion coefficient is small, having a large adhesion area does not pose any problem. However, in a case where the difference in the linear expansion coefficient is large, it is better to have a smaller adhesion area as this leads to suppression of the internal stress, and it is better to have larger widths of the grooves. Generally, as the widths of the grooves or areas occupied by the grooves are increased, a joint area of the optical component is reduced.

For example, in a case of using silica (having a linear expansion coefficient of 6.0×10⁻⁶/° C.) close to the linear expansion coefficient of the optical component 4 in the reinforcing substrate 11 and using LN having a large difference in the linear expansion coefficient with respect to the optical component 4 in the reinforcing block 3, it is preferable to set the width h1 of the groove to be larger than h2 and further reduce the joint area between the reinforcing block 3 and the optical component 4.

FIGS. 9A to 9C are diagrams illustrating a configuration for further reducing an area of the central butting part. The grooves can have cross-sectional shapes of trapezoids as in FIGS. 9A and 9B or triangles as in FIG. 9C. For example, angles of inner surfaces of the grooves in FIG. 9A are θ1=60 degrees, θ2=120 degrees, and θ3=90 degrees, or angles of inner surfaces of the grooves in FIG. 9B are θ1=60 degrees, θ2=120 degrees, and θ3=120 degrees. In FIG. 9C, θ1=60 degrees, θ2=90 degrees, and θ4=30 degrees can also be set.

As illustrated in FIGS. 9A to 9C, in a case where large internal spaces of the grooves can be secured, the grooves cannot be completely filled with the adhesive AD. Even in this case, the central protruding part is joined to the substrate 1 and the reinforcing block 3 through the adhesive layer, and the adhesive overflowing into the grooves also contributes to joining. However, even in a case where, for example, the adhesive in the grooves expands thermally because of a change in a temperature, there is a space without the adhesive. Thus, the internal stress is unlikely to be generated.

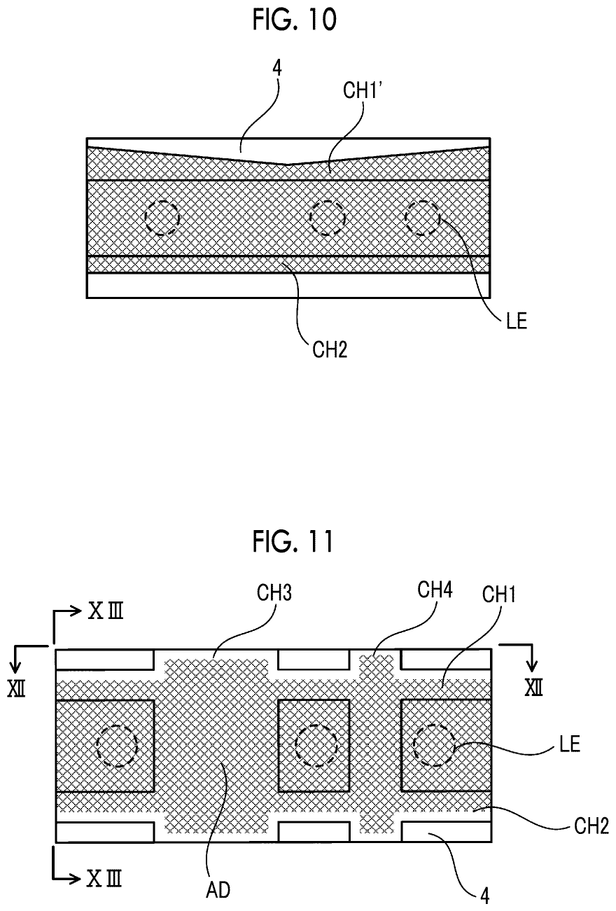

As illustrated in FIG. 10, shapes of the grooves are also not limited to the grooves having fixed widths. The width of at least one groove may be changed in the middle of the groove. In FIG. 10, the width of the upper groove CH1 is changed.

As illustrated in FIG. 11, the grooves (CH1 to CH4) can also be disposed such that individual butting portions are formed to correspond to the input portion or the output portion of the optical waveguide.

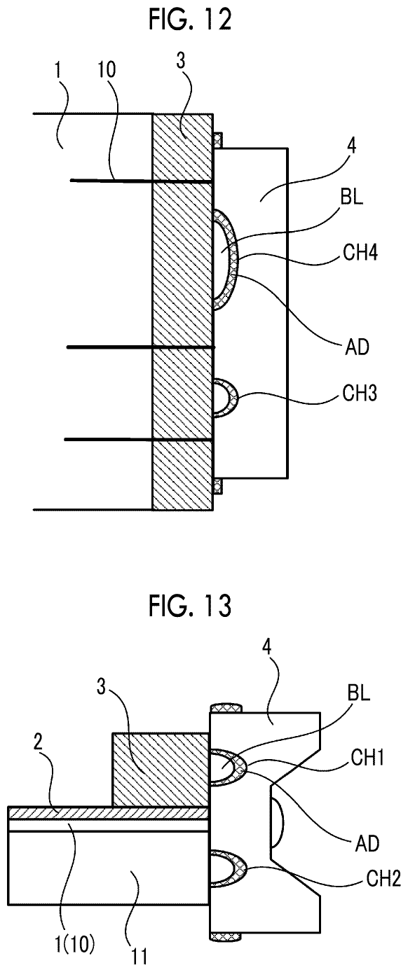

A groove (CH3) can be provided in only a location of a large clearance in the optical waveguide without providing a groove (for example, the groove CH4) in a location of a small clearance in the optical waveguide. As illustrated in FIGS. 12 and 13, the shapes of the grooves can also be set such that the inner surfaces of the grooves are curved surfaces. In a case where an amount of the adhesive is a small amount, the adhesive AD is disposed along the inner surfaces of the grooves, and an air bubble BL (a part without the adhesive) is formed, as illustrated in FIGS. 12 and 13. The adhesive in the grooves suppresses generation of the internal stress based on an effect of the air bubble BL.

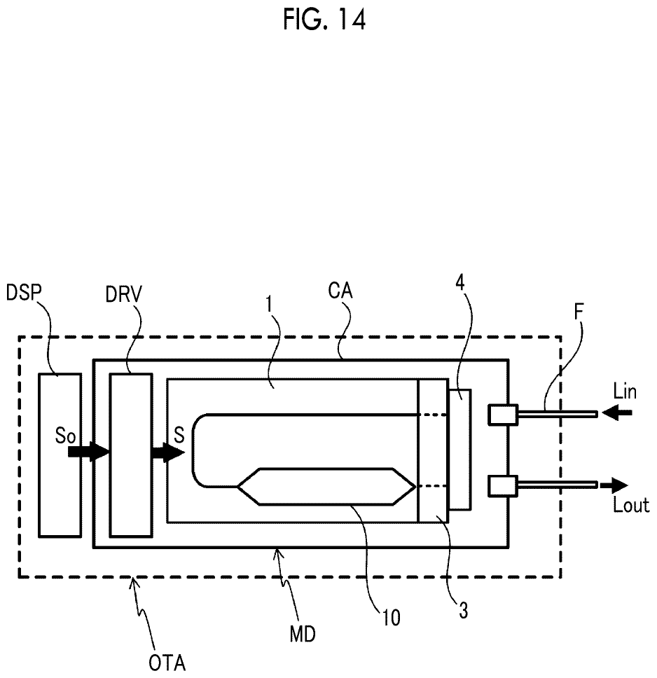

In the optical waveguide device of the present invention, a modulation electrode that modulates the light wave propagating through the optical waveguide is provided in the substrate 1, and the optical waveguide device is accommodated inside a case CA as illustrated in FIG. 14. An optical modulation device MD can be further configured by providing an optical fiber F through which the light wave is input into the optical waveguide or output from the optical waveguide. The optical fiber can not only be disposed outside the case CA as in FIG. 14 but also be fixedly disposed by introducing the optical fiber into the case through a through-hole that penetrates through a side wall of the case.

An optical transmission apparatus OTA can be configured by connecting, to the optical modulation device MD, an electronic circuit (digital signal processor DSP) that outputs a modulation signal So causing the optical modulation device MD to perform a modulation operation. A modulation signal S to be applied to the optical waveguide device needs to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

### Industrial Applicability

As described above, according to the present invention, an optical waveguide device that reduces internal stress generated in a joint portion between a substrate or a reinforcing block and an optical component and that suppresses residual air bubbles in an adhesive can be provided. An optical waveguide device configured not to have residual air bubbles on an optical axis or a propagation optical path of a light wave even in a case where air bubbles remain in an adhesive can also be provided. An optical modulation device and an optical transmission apparatus using the optical waveguide device can also be provided.

### REFERENCE SIGNS LIST

1 Substrate (for example, LN substrate)
2 Upper surface-side layer
3 Reinforcing block
4 Optical component (optical block)
10 Optical waveguide
11 Reinforcing substrate
AD Adhesive
CH1 to CH4 Groove
CA Case
CN1 to CN3 Butting part
MD Optical modulation device
OTA Optical transmission apparatus

1. An optical waveguide device comprising:
a substrate on which an optical waveguide is formed;
a reinforcing block disposed on the substrate along an end surface of the substrate on which an input portion or an output portion of the optical waveguide is disposed; and
an optical component joined to end surfaces of the substrate and the reinforcing block,
wherein grooves are disposed near a part corresponding to the input portion or the output portion on a joint surface of the optical component, and a part of the grooves reaches up to a side surface adjacent to the joint surface.

2. The optical waveguide device according to claim 1,
wherein the joint surface of the optical component includes a butting part divided by the grooves, and the butting part is disposed at each of a position corresponding to the substrate and a position corresponding to the reinforcing block.

3. The optical waveguide device according to claim 1,
wherein the grooves are a plurality of straight lines laterally crossing the joint surface of the optical component.

4. The optical waveguide device according to claim 3,
wherein the grooves include at least two grooves of straight line shapes which interpose the input portion or the output portion of the optical waveguide in an up-down direction.

5. The optical waveguide device according to claim 4,
wherein a width of a groove in the up-down direction at a position corresponding to the reinforcing block is larger than a width of a groove in the up-down direction at a position corresponding to the substrate.

6. An optical modulation device comprising:
the optical waveguide device according to claim 1 including an electrode that modulates a light wave propagating through the optical waveguide;
a case accommodating the optical waveguide device; and
an optical fiber through which the light wave is input into the optical waveguide or output from the optical waveguide.

7. The optical modulation device according to claim 6,
wherein an electronic circuit that amplifies a modulation signal to be input into the optical waveguide device is provided inside the case.

8. An optical transmission apparatus comprising:
the optical modulation device according to claim 6; and
an electronic circuit that outputs a modulation signal causing the optical modulation device to perform a modulation operation.
